(19) United States
(12) Patent Application Publication
(10) Pub. No.: US 2020/0268578 A1
(43) Pub. Date: Aug. 27, 2020

(54) Hydro-chair

(71) Applicant: Lamisha Fleming, San Antonio, TX (US)

(72) Inventor: Lamisha Fleming, San Antonio, TX (US)

(21) Appl. No.: 16/872,935

(22) Filed: May 12, 2020

Related U.S. Application Data
(63) Continuation-in-part of application No. 15/396,639, filed on Dec. 31, 2016, now abandoned.
(60) Provisional application No. 62/274,011, filed on Dec. 31, 2015.

(51) Int. Cl. A61G 5/14; A61G 5/10

(52) U.S. Cl. CPC A61G 5/14; A61G 5/104; A61G 2200/36; A61G 2200/34; A61G 2203/70

(57) ABSTRACT

The invention is directed to a hydraulic assisted machine in the form of a wheelchair that aids in handicapped personnel with many types of disabilities, aids with medical personnel, caregivers, hospitals, rehabilitation services, etc. also providing little to no assistance for the disabled. The materials used for construction of such machine is a structured based metal, or metallic alloy, rubber, plastic metal, polyester, and leather. Special features enabled in the wheelchair are: Hydraulic lift with springs, armchair remote, Lift assist tilting. This invention provides for a wheelchair including a hydraulic pump below the patient seat panel actuated using a remote or a hand gear or a push button to lift the user to their feet without limited or no help.

### CROSS REFERENCE TO RELATED APPLICATIONS

This application is a continuation in part of U.S. application Ser. No. 15/396,639 filed Dec. 31, 2016, which claims priority to U.S. Provisional Application No. 62/274,011, filed on Dec. 31, 2015. Both of the aforementioned applications, U.S. Ser. No. 15/396,639 and U.S. 62/274,011, are incorporated herein by reference in their entireties.

### BACKGROUND OF THE DISCLOSURE

### Field of the Invention

The present invention generally relates to improvements in wheelchairs to enable the disabled patient to stand up with little or no assistance.

### Description of the Related Art

The art is replete with a wide variety of prior art devices, designed to assist the wheelchair users in achieving a standing position from a sitting position. Such devices have ranged from simple handrails, which require the user to lift most of his or her body weight without mechanical assistance, to fully mechanized devices which perform the lifting and support functions almost completely independently of the user of the device.

Wheelchairs, as a matter of interest to hospitals, patient facilities, and private persons, are a major concern. For the most part, wheelchairs are designed to transport patients from one location to another with a minimum of difficulty. Indeed, most wheelchairs include the capability of allowing the wheelchair occupant to move the chair of his own accord. Predominantly, this is done using human arm and hand power. However, there are those designs that involve motorized driving means.

In cases where a patient is capable of driving their own chair, the difficulties of the hospital or support staff that may be concerned with such propulsion are minimal. Usually, such handicapped persons can manage for themselves and are able to help the attendant in whatever fashion necessary during transfer to and from the wheelchair. However, there is a much larger concern when medical officials are required to move a patient that is incontinent or has the functional loss of one or more limbs. Such patients often must be moved completely with the help of others as they do not have the capacity of independent motion. In such circumstances, especially in the hospital environment, these patients may require the help of two or more attendants to move the individual from chair to bed or vice versa.

Wheelchairs are already known, which are especially used for paraplegic patients, and which enable the patient to stand up. It is indeed a recognized fact today, that it is necessary for multiple reasons—and in particular physiological and psychological ones—to enable a handicapped person to stand up to a vertical position during the day. This operation which many specialists call “uprighting”, has been essentially developed with the help of fixed installations giving the handicapped person the facilities of standing up.

Certain wheelchairs have a movable seat and backrest, which also enable the patient to stand up. Various prior arts have disclosed chair extensions for example, U.S. Pat. No. 3,964,786 issued Jun. 22, 1976 to Mashuda discloses a wheelchair in which the seat, back and leg portions are so articulated and separately actuable, by power means, under control of the occupant, as to enable the occupant to assume any of one of three positions, either sitting, standing or reclining. From the figures and description, it does not appear that the anthropometric averages would be maintained.

U.S. Pat. No. 4,437,537 issued Mar. 20, 1984 to Ausmus describes an occupant operated motor driven vehicle for supporting handicapped occupants adapted to be tilted forward by the occupant for retrieving articles lying on the vehicle's support surface, and to be restored to vertical operating position. The platform means does not appear to be integrated into any sort of wheelchair, nor does it appear to maintain anthropometric averages.

U.S. Pat. No. 4,456,086 issued Jun. 26, 1984 to Wier et al. discloses an integrated wheelchair and ambulator which allows a paraplegic to stand, although it contains a platform which is undesirable in order to maintain anthropometric averages. Therefore, it is a primary object of the present invention to provide an invalid mobility device or stand-up wheelchair in accordance with the present invention which is capable of allowing an invalid to stand, while maintaining the anthropometric averages to allow the invalid to experience approximate normal motion and simulated normal activities and mobility but will allow routine functions to be performed like non-invalid counterparts.

The foregoing patents reflect the state of the art of which the applicant is aware and are tendered with the view toward discharging applicant's acknowledged duty of candor in disclosing information which may be pertinent in the examination of this application. It is respectfully stipulated, however, that none of these patents teach or render obvious, singly or when considered in combination, applicant's claimed invention.

It is therefore desirable to have a dependable, mechanically simple device to enable even persons with a full lower body disability to easily and safely move themselves between sitting and standing positions while utilizing their own skeletal structure for support. Additionally, it is desirable that such a device is enabled with lift assisting tilting that is suitable for all types of disabled patients.

### SUMMARY OF THE INVENTION

In view of the foregoing disadvantages inherent in the known types of wheelchair in the prior art, the present invention provides an improved wheelchair for better mobility of people with disabilities. As such, the general purpose of the present invention, which will be described subsequently in greater detail, is to provide a new and improved arrangement for a wheelchair, which has all the advantages of the prior art and none of the disadvantages.

It is an object of the present invention to provide an improved wheelchair. With the instant apparatus, the transportation and handling of disable patients in simple way requiring no help. Accordingly, one of the objects of the present invention is to provide an improved wheelchair that facilitates the movements of patients from sitting position in a wheelchair to standing position.

This invention provides for a wheelchair including a hydraulic pump below the patient seat panel actuated using a push button to lift the user to their feet without limited or no help. Thus, the attendant is not required to summon help as he or she does not need to physically lift the patient from the chair. The individual may be moved from the seated position to standing posture. The wheelchair has large rear wheels that allow the patient to be independently mobile. The use of the large rear wheels allows the patient to push himself to whatever destination they may have in mind.

An aspect of the invention is to provide a hydro wheelchair having an adjustable seat belt for safety of the patient from falling during using the chair.

Another aspect of the invention is to provide a hydro wheelchair having a lift and tilt feature.

Still another aspect of the invention is to provide a hydro wheelchair having a remote control or push button or hand gear.

Still another aspect of the invention is to provide a hydro wheel chair which is susceptible of a low cost of manufacture with regard to both materials and labor, and which accordingly is then susceptible of low prices of sale to the consuming public, thereby making such wheelchair economically available to the buying public.

It is still another aspect of the present invention to provide a hydro wheelchair which may be easily and efficiently manufactured and marketed.

It is a further aspect of the present invention to provide a hydro wheelchair is of a durable and reliable construction.

Other aspects of the present invention will become apparent from time to time throughout the specification as hereinafter related. There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting. Other features and aspects will be apparent from the following detailed description, the drawings, and the claims

### BRIEF DESCRIPTION OF THE DRAWINGS

To further clarify various aspects of some example embodiments of the present invention, a more particular description of the invention will be rendered by reference to specific embodiments thereof wheelchair illustrated in the appended drawing. It is appreciated that the drawing depicts only illustrated embodiments of the invention and are therefore not to be considered limiting of its scope. The invention will be described and explained with additional specificity and detail through the use of the accompanying drawings.

FIG. 1 is a side view of a wheelchair of the present invention.

FIG. 2 shows an embodiment of a wheelchair of the disclosure.

FIG. 3 shows another embodiment of a wheelchair of the disclosure.

FIG. 4 shows another embodiment of a wheelchair of the disclosure.

FIG. 5 shows another embodiment of a wheelchair of the disclosure.

FIG. 6 shows another embodiment of a wheelchair of the disclosure.

FIG. 7 shows another embodiment of a wheelchair of the disclosure.

FIG. 8 shows another embodiment of a wheelchair of the disclosure.

FIG. 9 shows another embodiment of a wheelchair of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings. As used in this specification and the appended claims, the singular forms “a”, “an”, and “the” include plural referents unless the content clearly dictates otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art, the present disclosure and will not be interpreted in an idealized or overly formal sense unless expressly so defined herein.

In some preferred embodiments, the present invention provides an improved wheelchair for disables to enable them to move themselves to stand up without any support from caregivers. The purpose of the invention is to provide a user friendly, dependable, mechanically simple device to enable even persons with a full lower body disability to easily and safely move themselves while utilizing their own skeletal structure for support.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

Referring to the invention now in more detail, the invention is directed to a hydraulic assisted machine in the form of a wheelchair that aids in handicapped personnel with many types of disabilities, aids with medical personnel, caregivers, hospitals, rehabilitation services, etc. also providing little to no assistance for the disabled. The materials used for construction of such machine is a structured based metal, or metallic alloy, rubber, plastic metal, polyester, and leather. Special features enabled in the wheelchair are: Hydraulic lift with springs, armchair remote, Lift assist tilting. This invention provides for a wheelchair including a hydraulic pump below the patient seat panel actuated using a remote or a hand gear or a push button to lift the user to their feet without limited or no help. Thus, the attendant is not required to summon help as he or she does not need to physically lift the patient from the chair. The individual may be moved from the seated position to standing posture.

The wheelchair has large rear wheels that allow the patient to be independently mobile. The use of the large rear wheels allows the patient to push himself to whatever destination they may have in mind. The hydro wheel chair is having an adjustable seat belt for safety of the patient from falling during using the chair and has a lift and tilt feature.

The process of using the wheelchair of the present invention includes:

Locking the wheels in place;

Ensuring that the seat belt is on person for safety precaution if needed;

Folding in feet flaps near the feet;

Pressing the remote-control button to raise the user to the desired level of height, then tilting the chair allowing person to come in a standing position;

Unbuckling the seat belt adjustment if used.

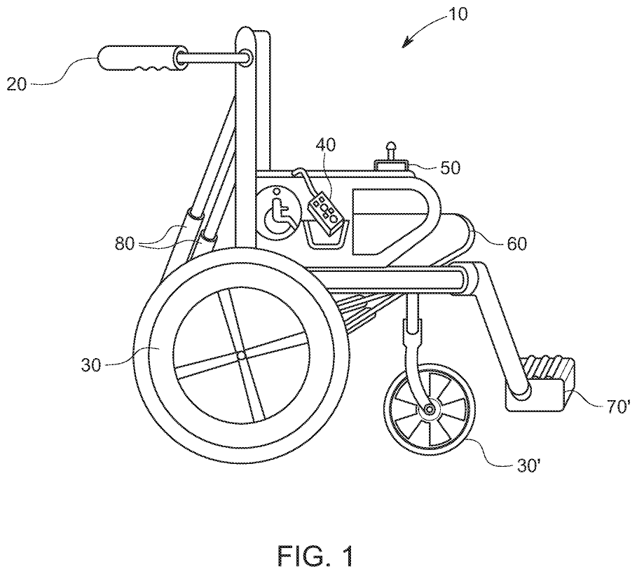

Referring to the FIG. 1 that depicts the wheelchair assembly showing the various components of the wheelchair of the invention. Illustrated are push handle (20), the wheels both small and big in size (30), remote control (40), hand gear (50), seat (60), and foot rest (70) of the hydro chair (10) according to the preferred embodiment of the invention. In a preferred embodiment of the invention an optional cup holder is added for easy use by the patient to keep the glasses while using the chair. Yet another preferred embodiment of the invention provides use of hand gear (50), eliminating the use of a remote control (40).

The present invention a hydro wheelchair (10) helps people with different disabilities that cannot stand due to injuries or handicaps, or chronic illness, and because of disabilities they cannot walk long periods of times nor do daily tasks and some that is limited to standing. The hydro wheelchair (10) can be easily utilized by patients with shortness of breath and help patients that are confined to wheelchairs to move freely and also help them in being put in beds with a little assistance. The invention targets to give people with disabilities to stand a little and help them to be more independent with activities of daily living. Further, the hydro chair helps medical staff & doctors, caregivers, family members who handle such patients and prevents them from having spinal injuries, back injuries, and muscle sprains, spams due to lifting such patients. Furthermore, the hydro chair helps patients to stand on their feet to get in vehicles or any type of transportation with very little assistants.

The advantages of the current invention include the remote control enables wheelchair that functions to lift, tilt and even move the chair and it is suitable for all types of the disabled and or handicapped patients of all possible weight. The wheelchair can be handled by the patient both alone and with very less personal assistance. Assistance only needed when transporting the patient to one point to another, i.e. move to the bed, to the table, or to the bathroom.

A wheelchair thus comprises a hydraulic lift with springs, control, Lift assist tilting, seat belt wherein said wheelchair is used for lifting a person

The lifted person may be a handicapped person with many types of disabilities. The lifting of the person may be from sitting to standing position without any help. The lifting of the person is from sitting to standing position with minimum help. The lifting of the person may be from sitting to standing position with no help.

The wheelchair may use a structured based metal. The wheelchair may use metallic alloy, rubber, plastic metal, polyester, and leather. The seat belt may be adjustable for safety of the patient from falling during using the chair.

The control may be remote control in armchair. The control may be battery operated. The control may be push button. The control may be hand gear.

A process of using the wheelchair includes locking the wheels in place; ensuring that the seat belt is on person for safety precaution; folding in feet flaps near the feet; pressing the remote-control button to raise the user to the desired level of height; tilting the chair, allowing the person to come in a standing position; unbuckling the seat belt adjustment if used.

FIG. 1, as described above, shows the wheelchair at its normal (unraised) position/height.

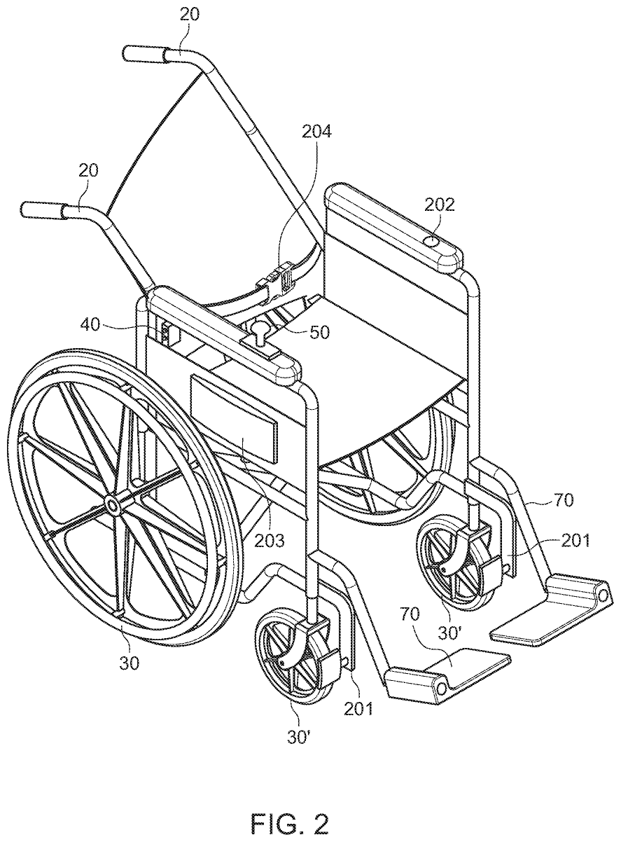

FIG. 2 shows wheelchair 200 reclined at approximately 135 degrees. FIG. 2 further shows front wheels 30′ with wheel locks 201, pocket 203, seat belt 204, and cup holder 202.

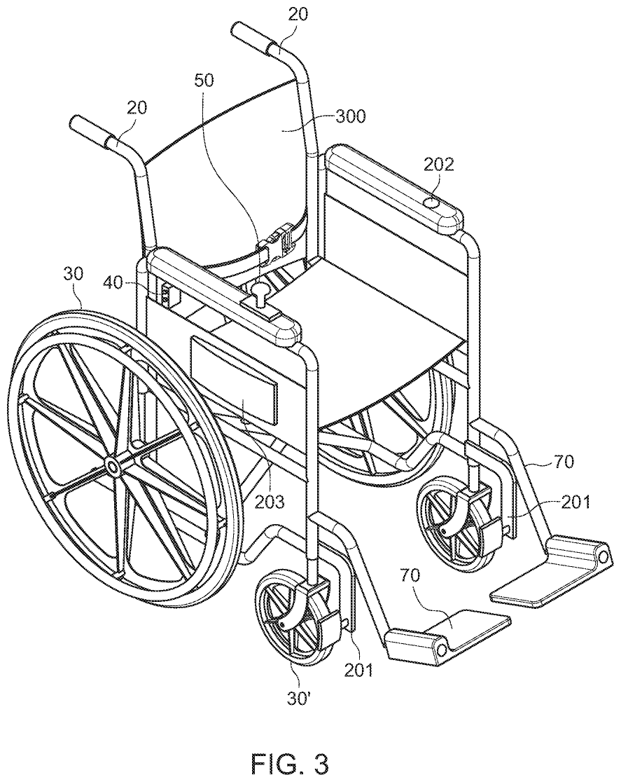

FIG. 3 shows wheelchair 300 at a desired level of height of approximately 29-32 inches.

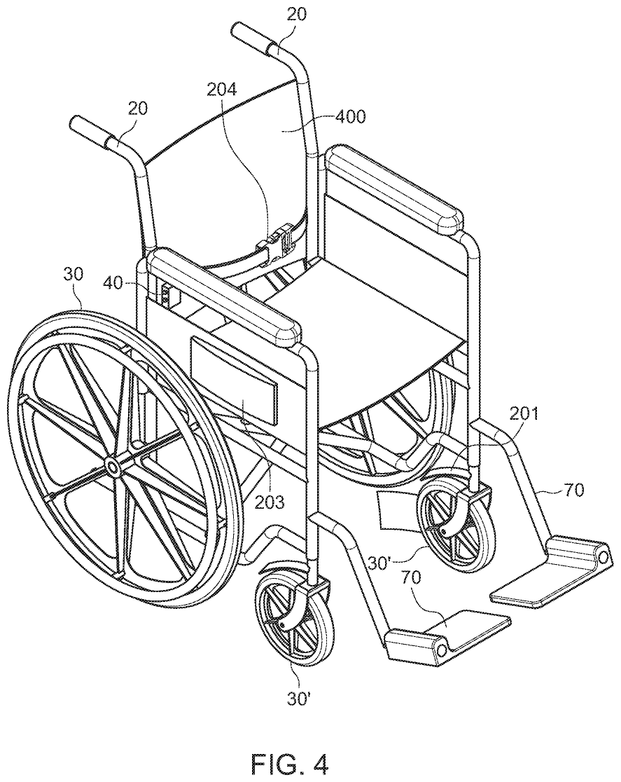

FIG. 4 shows wheelchair 400 at a desired level of height of approximately 36 inches.

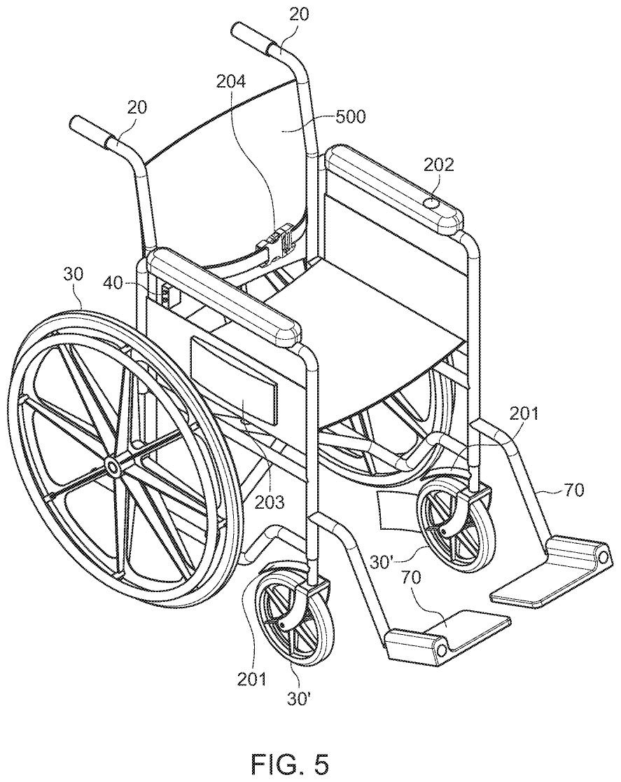

FIG. 5 shows wheelchair 500 at a desired level of height of approximately 42 inches.

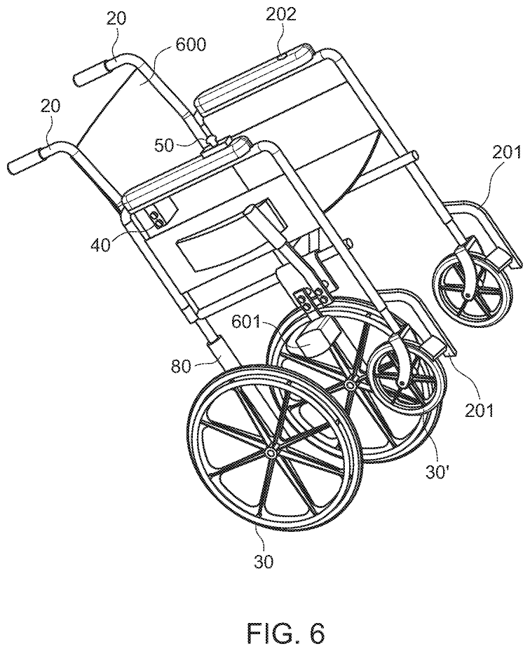

FIG. 6 shows wheelchair 600 in a back tilted position. FIG. 6 further shows front/back gear locks 601 and hydraulic cylinder 602.

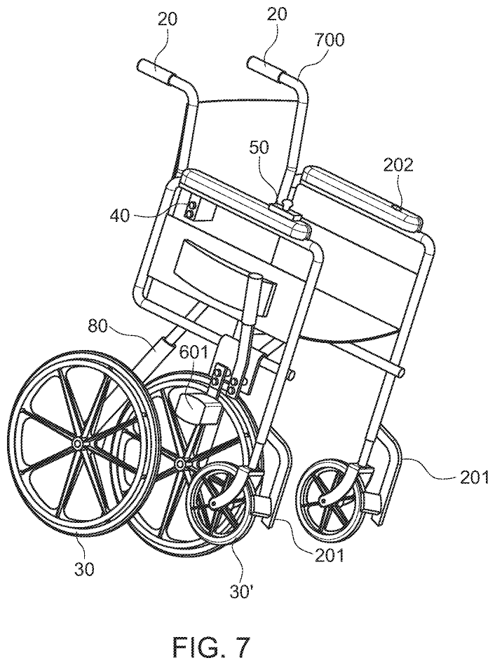

FIG. 7 shows wheelchair 700 in a tilted position. FIG. 7 shows wheel locks 201. In embodiments, the wheel locks contact the ground when the wheelchair is tilted forward. The wheelchair can make contact with the ground through the wheel locks to stabilize the chair while a patient lifts out of the chair as exemplified in FIG. 7.

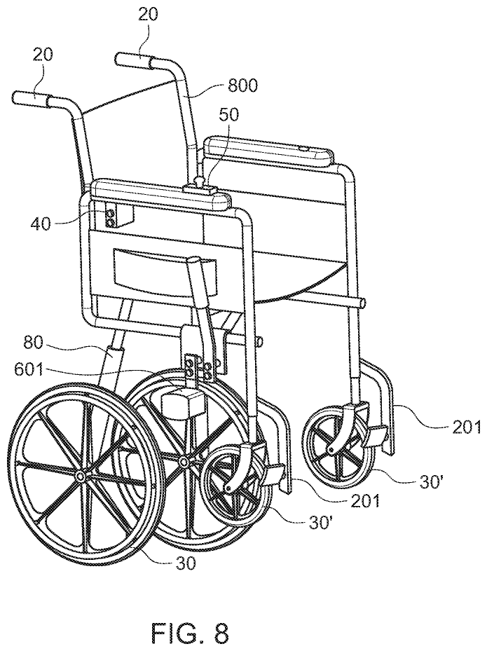

FIG. 8 shows wheelchair 800 in a tilted front position.

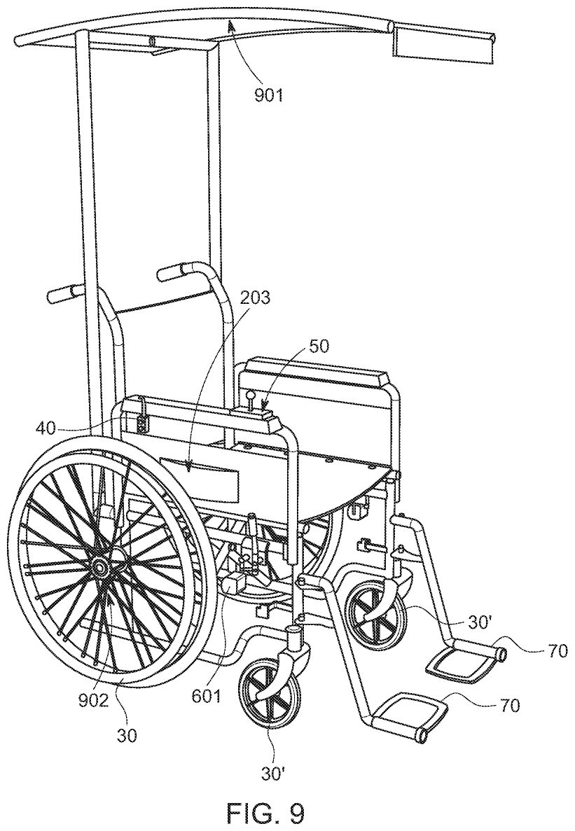

FIG. 9 shows wheelchair 900 with a detachable umbrella canopy 901 to cover user in different weather conditions. Wheelchair 900 also includes a steel support coated with a reflector 902 allowing the wheelchair 900 to be seen under dark conditions. It is noted that hand gear 50 can be a battery-operated automatic gear shift system to make the wheelchair drivable (i.e. motorized) to a desired location. In embodiments, the hand gear 50 can be clicked side to side for mobility and the other direction used to adjust the chair's inclination.

In addition, the wheelchair on the back can have two adjustable straps on left side to hold oxygen tanks. The Hydro-Chair also raises so a user can, for example, get items in a kitchen cabinet up high, when a user goes grocery shopping if they want a certain item, etc., on a high shelf they can raise the chair to reach it. Furthermore, the Hydro-Chair seat can be cushioned at least about 1½ to about 2½ inches including the back cushion for leaning back on when sitting for comfort.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Plural instances may be provided for components, operations or structures described herein as a single instance. Finally, boundaries between the various components are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

In addition, while this disclosure includes specific examples, it will be apparent after an understanding of the disclosure of this application has been attained that various changes in form and details may be made in these examples without departing from the spirit and scope of the claims and their equivalents.

I claim:

1. A wheelchair comprising:
a seat;
front wheels and rear wheels;
a chair configured to raise to a desired level of height;
an hydraulic system configured to raise the chair in height;
rear wheel locks; and
front wheel locks,
wherein when the front wheels are locked, the wheelchair is capable of tilting forward via the front wheels, and resting on the front wheel locks through contact between the front wheel locks and the ground.

2. The wheelchair of claim 1, further comprising a hand gear configured to raise the wheelchair in height.

3. The wheelchair of claim 1, further comprising handles, footrests, a side pocket, and/or a remote control.

4. The wheelchair of claim 1, wherein the wheelchair is further configured to recline at positions ranging from approximately 90 degrees to approximately 135 degrees and a hand gear adjusts the chair's inclination and raises the wheelchair in height.

5. The wheelchair of claim 1, wherein the wheelchair can be raised to a desired level of height ranging between approximately 29 inches to approximately 42 inches above its normal height.

6. The wheelchair of claim 5, wherein the wheelchair can be raised to three desired levels of height of approximately 29-32 inches, approximately 36 inches, and approximately 42 inches.

7. A method of using the wheelchair of claim 1, comprising
locking the wheels in place,
raising a user to a desired level of height;
tilting the chair forward allowing the user to come to a standing position.

8. The method of claim 7, further comprising buckling a safety belt before locking the wheels in place, and unbuckling the safety belt after coming to a standing position.
